(19) United States
(12) Patent Application Publication
(10) Pub. No.: US 2014/0235518 A1
(43) Pub. Date: Aug. 21, 2014

(54) AQUEOUS LIQUIDS CONTAINING AN ORGANIC COMPOUND AND AN N-(2-HYDROXYALKYL) SUBSTITUTED N-ALKYLAMINE

(71) Applicant: TAMINCO, Gent (BE)

(72) Inventors: Michael David Gernon, Phoenixville, PA (US); Kurt Buyse, Brugge (BE)

(73) Assignee: TAMINCO, Gent (BE)

(21) Appl. No.: 14/347,883

(22) PCT Filed: Sep. 27, 2012
(86) PCT No.: PCT/EP2012/069109

§ 371 Date: Mar. 27, 2014

Related U.S. Application Data
(60) Provisional application No. 61/540,062, filed on Sep. 28, 2011.

(30) Foreign Application Priority Data
Sep. 28, 2011 (EP) 11183191.3

(51) Int. Cl. C09K 5/10; C10M 133/08

(52) U.S. Cl. CPC C09K 5/10; C10M 133/08
USPC 508/562; 252/77; 516/67

(57) ABSTRACT

Aqueous liquids containing an organic compound and an N-(2-hydroxyalkyl) substituted N-alkylamine, which can be used in emulsion lubricants, emulsion coolants and metalworking fluids resulting in excellent biostability, emulsion stability and overall performance.

The present invention relates to a liquid that contains water, an organic compound and at least 100 mg/kg of an N-(2-hydroxyalkyl) substituted N-alkylamine. The organic compound is immiscible with water, i.e., it may be soluble to some extent in water but the organic compound and water do not mix in all proportions to form a homogenous solution; at least in some proportions, water and the organic compound do not form a solution. The invention also relates to the use of the liquid as a metalworking fluid, an emulsion lubricant, a coolant, a synthetic lubricant and/or a partially aqueous functional fluid.

### BACKGROUND OF THE INVENTION

The use of alkanolamine type neutralizing agents in metalworking fluids, emulsion lubricants, emulsion coolants, full synthetic lubricants and full synthetic coolants is well known. Alkanolamines are added to such formulations to adjust and buffer the pH. Alkanolamines are also used for ancillary benefits of improved corrosion inhibition, better emulsion stability and greater resistance to biological growth. A description of a large compilation of N-alkylalkanolamines (AAA's) useful in metalworking fluids was published by Bennett in 1979 (Bennett, E. O.; Lubrication Engineering 1979, 35(3), 137-144). In this publication, Bennett showed that certain alkanolamines are markedly more effective than others as supplementary biostabilizing (by biostabilizing is meant stabilized against biological growth) agents, and Bennett deduced several correlations of AAA structure with degree of supplementary biostabilization. In particular, longer N-alkyl chains were found to be more effective than shorter chains and secondary AAA's were more effective than tertiary AAA's. In subsequent patents (e.g. U.S. Pat. No. 4,749,503), Bennett described particularly effective N-alkylalkanolamines such as N-hexylethanolamine. Since Bennett's original work, a number of authors and inventors have discovered additional attributes of N-alkylalkanolamines that provide for added benefits. In U.S. Pat. No. 5,132,046, Edebo et al. describe more specific metalworking fluid formulas with added biostability. In WO 2005/055720, Gernon et al. describe the benefits of blends of secondary and tertiary AAA's. Brutto et al. in US 2011/0046140 discuss a set of primary aminoalcohols intended for use in metalworking formulations, and many similar articles and patents have been published over the past several decades.

In order to simplify the structures of the alkanolamines, the following designations are used in the present specification: EO=2-hydroxyethyl group; PO=2-hydroxypropyl group, BO=2-hydroxybutyl group; PnO=2-hydroxypentyl group; HexO=2-hydroxyhexyl group; HepO=2-hydroxyheptylgroup; OctO=2-hydroxyoctyl group; Et=ethyl group; Pr=propyl group; iPr=isopropyl group; Bu=butyl group. An amine's structure is given by designating the N-alkyl group with an N (designating nitrogen) followed by the two hydroxyalkyl groups in parenthesis. Thus, BuN(EO)(BO) is N-2-hydroxybutyl N-2-hydroxyethyl butylamine.

Some of the alkanolamines used in the present invention are already known per se, but not in the formulations/uses indicated hereabove. Perrault (Perrault, G.; Canadian Journal of Chemistry (1968), 46(12), 2021-5 & Perrault, G.; Canadian Journal of Chemistry (1967), 45(10), 1063-7) has previously published two studies of the correlation of alkanolamine structure with pKa wherein EtN(EO)(BO) and PrN(EO)(BO) are mentioned. Hashida et al. (U.S. Pat. No. 7,115,373 B2) mentions EtN(EO)(BO), EtN(PO)(BO), PrN(EO)(BO), PrN(PO)(BO) and PrN(BO)(BO) as five candidates out of thousands of molecules tested for therapeutic activity against allergic diseases. Wilk (Wilk, K.; Polish Journal of Chemistry (1988), 62(7-12), 895-898) mentions EtN(PO)(BO), PrN(PO)(BO) and BuN(PO)(BO) as part of an academic study of the reaction of alcohols and thiols with oxiranes and thiiranes.

Commercial applications of the N-alkylalkanolamines (AAA's) described herein are not discussed in the prior art. Golec et al. (Golec, K.; Hill, E. C.; Kazemi, P.; Skold, R. O.; Tribology International (1989), 22(6), 375-382) mentions BuN(EO)(PO) as a potential alkanolamine component of metalworking fluids, but this AAA does not contain sufficient hydrophobic character within the hydroxyalkyl groups to display the benefits described herein. In addition, several references discuss unrelated uses of tertiary N-methyl alkanolamines (e.g., WO 2000/006678 A1; use as intermediates in the preparation of quaternary ammonium surfactants). Tertiary N-methylalkanolamines, which are not described herein, may bear superficial structural similarity to the alkanolamines described herein, but the hydrophobic character of the N-methyl group within these molecules is insufficient to provide for the benefits described herein.

It is an object of the present invention to provide amines, which when used as components of metalworking fluids, related aqueous based lubricants, coolants and functional fluids, provide improvements in biostability, emulsion stability and overall performance.

### DESCRIPTION OF THE INVENTION

To this end, the present invention relates in one aspect to a liquid containing water, an organic compound which forms a biphasic system with water and at least 100 mg/kg of a tertiary alkanolamine of the following formula (I):

R—CH(OH)CH₂—NR′—CH₂CH(OH)—R″ (I)

wherein:
R=hexyl, pentyl, butyl, propyl, ethyl or a structural isomer of hexyl, pentyl, butyl or propyl
R′=butyl, sec-butyl, isobutyl, tert-butyl, propyl, isopropyl or ethyl
R″═H or methyl or hexyl, pentyl, butyl, propyl, ethyl or a structural isomer of hexyl, pentyl, butyl or propyl.

The organic compound is immiscible with water. This means that the organic compound and water do not mix in all proportions to form a homogenous solution. At least in some proportions, they do not form a solution. However, the term “immiscible” does not exclude that the organic compound may be soluble to some extent in water or that the water may be soluble to some extent in the organic compound. The organic compound in particular is a biodegradable compound.

The liquids of the invention may take the form of any of the liquids mentioned herein, in particular of a metalworking fluid, an emulsion lubricant, a coolant, a synthetic lubricant, or a partially aqueous functional fluid. One aspect of the invention concerns a metalworking fluid, an emulsion lubricant, a coolant, a synthetic lubricant or a partially aqueous functional fluid comprising a liquid containing water, an organic compound, and a tertiary alkanolamine, said liquid being as specified herein. The metalworking fluid, emulsion lubricant, coolant, synthetic lubricant or partially aqueous functional fluid may be prepared starting from a liquid containing water, an organic compound and a tertiary alkanolamine as specified herein.

It has been found that the use of such amines as components of the liquids mentioned herein such as metalworking fluids, related aqueous based lubricants, coolants and functional fluids, provided for unexpected improvements in biostability, emulsion stability and overall performance.

Thus in a further aspect, the present invention concerns the use of a liquid containing water, an organic compound and a tertiary alkanolamine as defined herein as a metalworking fluid, an emulsion lubricant, a coolant, a synthetic lubricant and/or a partially aqueous functional fluid.

The present invention also concerns the use of a tertiary amine of formula (I) as defined herein for increasing the physical stability of an emulsion as specified herein. Or alternatively, the present invention concerns a method of increasing the physical stability of an emulsion as specified herein, said method comprising adding a tertiary amine of formula (I) as defined herein to said emulsion. The said tertiary amine of formula (I) may be added during the preparation of the emulsion or after the emulsion having been prepared or by a combination thereof.

The present invention also concerns the use of a tertiary amine of formula (I), as defined herein, for inhibiting microbial growth in a liquid as specified herein. Or alternatively, the invention concerns a method of inhibiting microbial growth in a liquid as specified herein, said method comprising the addition of a tertiary amine of formula (I), as defined herein, to said liquid. The tertiary amine of formula (I) may be added in an amount effective to inhibit microbial growth in said liquid. A skilled person can derive effective amounts from the data presented herein. Such amounts may in particular correspond to the amounts of tertiary amine of formula (I) mentioned herein as present in the liquids of the invention.

The terms “liquid” and “fluid” are used herein inter-changeably.

Embodiments of the invention are those tertiary alkanolamines of formula I wherein one or more of the groups R, R′, or R″ have the meanings (a)-(c):

(a) R=hexyl, pentyl, butyl, propyl or ethyl; or R=hexyl, pentyl, butyl, propyl, ethyl or a structural isomer of hexyl, pentyl, butyl or propyl;

(b) R′=butyl, propyl, isopropyl or ethyl;

(c) R″═H or methyl; or R″=hexyl, pentyl, butyl, propyl or ethyl.

In one embodiment R″═H or methyl. In another embodiment R=hexyl, pentyl, butyl, propyl or ethyl and R′=butyl, propyl, isopropyl or ethyl. In another embodiment R=hexyl, pentyl, butyl, propyl, ethyl or a structural isomer of hexyl, pentyl, butyl or propyl. In another embodiment R & R″=hexyl, pentyl, butyl, propyl or ethyl and R′=butyl, propyl, isopropyl or ethyl. In the invention in general, and in all of these embodiments, the R and R″ groups are preferably different from one another.

Of particular interest are the tertiary alkanolamines of formula I wherein R is hexyl, pentyl, butyl, propyl or ethyl, R′ is ethyl, propyl or butyl, R″ is H.

In one embodiment, the liquid in accordance with the present invention may contain at least 1000 mg/kg (or 0.1% w/w) of the tertiary alkanolamine of formula I. In other embodiments, the liquid of the invention may contain at least 2 g/kg, or 5 g/kg, or 10 g/kg, or 20 g/kg, or 50 g/kg, of the tertiary alkanolamine of formula I.

The liquid of the invention may contain less than 0.5 kg/kg of said tertiary alkanolamine, in particular less than 0.2 kg/kg, or less than 0.1 kg/kg, or less than 50 g/kg, or less than 20 g/kg.

The liquid of this invention will usually contain at least 5 wt. %, in particular at least 10 wt. % and more particularly at least 15 wt. % of said organic compound which forms a biphasic system with water. Such liquids are often concentrates, for instance so-called LOSS (low oil semi-synthetic) concentrates, MOSS (medium oil semi-synthetic) concentrates and/or HOSS (high oil semi-synthetic) concentrates. The liquid of this invention usually contains less than 95 wt. %, in particular less than 90 wt. % and more particularly less than 85 wt. % of said organic compound. These liquids or concentrates can be diluted up to 20/1 with water prior to use. Such diluted liquids are also in accordance with the present invention so that in a particular embodiment of the invention the liquid of the invention thus contains at least 0.25 wt. % of said organic compound.

As used herein, values expressed in mg/kg or kg/kg refer to weight/weight ratios of an ingredient, in particular of a tertiary alkanolamine to the total weight of the liquid. Unless indicated otherwise, any % in relation to a combination of ingredients is w/w (weight/weight).

The liquid of the invention is basic and in one embodiment may have a pH of at least 8.

The selection of an alkanolamine for a liquid of the invention, in particular for a metalworking fluid and/or emulsion lubricant formulation, is influenced by the overall hydrophilic/hydrophobic properties of the amine. Amines can be analyzed in terms of the total number of carbon atoms divided by the combined number of hydroxyl, primary amino and secondary amino groups contained within the molecule. The tertiary amino nitrogen can be omitted from consideration for applications wherein the operating pH is typically above 8. The tertiary alkanolamines described herein contain no secondary amino (RR′NH) or primary amino (RNH₂) groups, and the applications described herein typically employ emulsions and/or solutions with pH values above 8.

The tertiary alkanolamines described herein have total C atom to OH group ratios of between 4 and 10. The molecule EtN(EO)(BO) has the lowest C/OH ratio of 4, and the molecule BuN(OctO)(OctO) has the highest C/OH ratio of 10. In one embodiment, the total C atom to OH group ratio is between 4 and 7.5, or between 4 and 7. BuN(OctO)(PO) is an example of an alkanolamine with a C/OH ratio of 7.5. A balanced degree of hydrophilic/hydrophobic character is ideal for many functional fluid applications, and many secondary and primary amines (i.e., amines containing NH groups and/or —NH₂ groups) with C to combined (OH+NH₂+NH) ratios of 4 to 10 are useful in functional fluid applications.

The term “functional fluid” refers to a liquid or solution that can be used in lubrication, corrosion inhibition and/or other machining applications, in particular in commercial applications. The term “partially aqueous” refers to a fluid (or liquid) that contains water but also contains other non-aqueous components. The latter in particular may be the organic compound specified herein.

Secondary and primary alkanolamines are structurally different from the tertiary amines described herein. The amines described herein are tertiary amines that possess unique skeletal arrangements of hydroxyalkyl and alkyl groups. All the alkanolamines currently known to be useful in metalworking, emulsion lubricant and functional fluid applications contain either N-2-hydroxyethyl or N-2-hydroxypropyl groups along with, optionally, N-alkyl groups. Alkanolamines wherein one of the traditional 2-hydroxyethyl or 2-hydroxypropyl groups has been augmented by an additional longer chain 2-hydroxyalkyl group (e.g., alkyl=linear C4-C8) have been found to exhibit improved performance in aqueous based lubricants and functional fluids. The alkanolamines described herein contain at least one N-2-hydroxybutyl, N-2-hydroxypentyl, N-2-hydroxyhexyl, N-2-hydroxyheptyl or N-2-hydroxyoctyl group, wherein the butyl, pentyl, hexyl, heptyl or octyl moiety corresponds to the R or R″ groups as defined herein, combined with the ethyl in the —CH(OH)—CH₂— fragment. The incorporation of these non-traditional 2-hydroxyalkyl groups leads to an alkanolamine with unique and advantageous properties.

One can obtain C to (OH+NH₂+NH) ratios of between 4 and 10 with known tertiary alkanolamines not containing a 2-hydroxyalkyl group with more than four carbons (e.g., N-butyldiethanolamine, N-pentyldiethanolamine, N-hexyldiethanolamine, N-heptyldiethanolamine, N-octyldiethanolamine, N-nonyldiethanolamine and N-decyldiethanolamine), but such materials do not display all of the benefits described herein. The amines described herein have unique properties when compared to traditional N-alkyldiethanolamines of identical C to combined (OH+NH₂+NH) ratio. For instance, N-(2-hydroxybutyl) N-(2-hydroxyethyl)ethylamine {HBHEEA; EtN(EO)(BO)} and N-butyldiethanolamine (BDEA) both have the same C to (OH+NH₂+NH) ratio of 4, but aqueous solutions of HBHEEA allow for significantly more stable oil/water emulsions than do aqueous solutions of BDEA.

In general, the metalworking fluids, emulsion lubricants, emulsion coolants, full synthetic lubricants and full synthetic coolants described herein are partially aqueous systems that are formulated as 0/W emulsions (oil in water emulsions), W/O emulsions (water in oil emulsions), clear aqueous solutions containing surfactant aggregates and/or something intermediate between an emulsion and an aqueous solution containing micelles, liposomes and/or related surfactant aggregates. Surfactants are, by definition, materials which accumulate at interfaces and/or form aggregates (e.g., micelles, liposomes) in aqueous solution, and reference to an aqueous solution containing surfactants should be understood to imply the presence of surfactant aggregates. The emulsions described herein may appear turbid or clear. In some cases, the fluids described herein will be produced commercially as an essentially homogeneous concentrate which converts, upon aqueous dilution prior to use, into an emulsion.

Emulsions prepared with the alkanolamines described herein tend to be more stable and to have smaller discrete phase particle size than do emulsions prepared with alkanolamines of the same C to combined (OH+NH₂+NH) ratio but without a hydroxyalkyl group containing 4 carbons or more. Emulsions are colloidal systems wherein a discrete phase of liquid drops is dispersed within a continuous phase of another immiscible liquid. When the discrete phase is a hydrophobic liquid with “oil-like” properties and the continuous phase is predominantly aqueous, the emulsion is called an oil in water (0/W) emulsion. When the discrete phase is predominantly aqueous and the continuous phase is a hydrophobic liquid with “oil-like” properties, the emulsion is called a water in oil (W/O) emulsion. Emulsions can be additionally characterized based on the size of the discrete phase drops. Emulsions are colloids consisting of two immiscible and deformable phases. Thus, surface tension will drive the discrete phase droplets of an emulsion into a spherical shape. Such spherical discrete phase drops can be characterized by an average diameter. When the average diameter of the emulsion discrete phase drops is less than 0.1 micron, the emulsion is referred to as a microemulsion and usually appears to be clear. When the emulsion is composed of discrete phase drops with average diameter greater than 1 micron, the emulsion is referred to as a macroemulsion and appears to be “milky” and cloudy. In certain cases, the liquid/liquid interfacial tension between the immiscible phases of the emulsion is low enough for entropic stabilizing forces to render the system thermodynamically stable. In such cases, the average droplet size becomes highly uniform and this size can be predicted by use of the energy balance equation:

ΔE=(γ_{water/oil})ΔA_{water/oil}−TΔS

γ_{water/oil}=interfacial tension between immiscible phases (discrete & continuous)

ΔA_{water/oil}=increase in the interfacial area of surface contact between phases

TΔS=favourable energy change in emulsion due to entropy

The ΔA_{water/oil} term denotes the increase in the interfacial area of surface contact between the two immiscible phases, and this value will always be positive. At high values of γ_{water/oil}, the overall ΔE for emulsion formation will be positive and the colloid will be thermodynamically unstable. A thermodynamically unstable emulsion may exist for a long time so long as the rate of phase coalescence is slow. The energy necessary to create a thermodynamically unstable emulsion is supplied by stirring, and such an emulsion will exist so as long as the energy input by stirring is not released via phase coalescence. At low values of γ_{water/oil}, the ΔE for emulsion formation will become negative and the emulsion will become thermodynamically stable. Under these conditions and by taking ΔE=0 at equilibrium, the above equation can be rearranged to:

(TΔS)/(γ_{water/oil})=ΔA_{water/oil}

The TΔS term is a complicated function of the number of oil drops (i.e., discrete phase drops), and the exact value of TΔS will have a nonlinear dependency on the increase in interfacial area. Once the TΔS term becomes sufficiently negative for an emulsion to be stable, then this emulsion will remain stable unless some extra-thermodynamic factor drives coalescence. For those conditions wherein the TΔS energy term is sufficiently negative to exceed the positive energy value of the (γ_{water/oil})ΔA_{water/oil} term, one can state that the required increase in interfacial area will be inversely proportional to the interfacial tension. The higher the increase in the interfacial area of an emulsion, the smaller will be the size of the discrete phase drop. For thermodynamically stable emulsions, the lower the interfacial tension between the two immiscible phases, the greater will be the spontaneous increase in the interfacial surface area and the smaller will be the discrete phase drop radius.

The equation for ΔA_{water/oil} can be rearranged to derive the average discrete phase oil drop radius r. It is easiest to scale values to one mole of oil (molar volume oil=volume of a coalesced mole of oil; molar area of oil=surface area of a mole of oil coalesced into a sphere):

ΔA(molar)_{water/oil}=(number of oil drops)×4πr²−molar area oil

ΔA(molar)_{water/oil}={(molar volume oil)÷(4/3)πr³}×4πr²−molar area oil

Assume the molar area of the oil is small enough to be ignored

ΔA(molar)_{water/oil}=3(molar volume oil)/r

r=3(molar volume of oil)/ΔA(molar)_{water/oil}

r={3(molar volume of oil)(γ_{water/oil})}/(TΔS)

Again, it can be seen that with all other things constant, lower values for the liquid/liquid interfacial tension lead to smaller values for the radius of the discrete phase drop.

Note that there is always a substantial increase in the interfacial area of oil/water contact in an emulsion. The increase in area for a thermodynamically stable emulsion can be determined as a function of the radius of the discrete phase drops formed and/or as a function of the number of drops formed:

r=radius of an oil drop in the emulsion

R=radius of sphere that the coalesced oil would form

n=number of drops in the emulsion

ΔA/A=normalized surface area increase

A=original surface area of the coalesced oil in the form of a sphere

ΔA/A=(4πr²n−4πR²)/(4πR²)

n=(4/3)πR³÷(4/3)πr³

n=(R/r)³

ΔA/A={4πr²(R/r)³−4πR²}/(4πR²)

ΔA/A=(4πR³/r−4πR²)/(4πR²)

ΔA/A=(R/r)−1

ΔA/A=(n^{1/3})−1

So an emulsion produced by converting an oil phase into 1 million equal drops will have an increase in contact surface area of about 100. One billion drops will lead to an increase in surface area of 1000. If the oil drops have r=1 micron and R=1 cm, then the relative increase in interfacial area is 10,000. If r=1 nm and R=1 cm, then the increase in interfacial area is 10,000,000. Note that only thermodynamically stable emulsions will have fairly uniform drop size. Thermodynamically unstable emulsions created by mixing will contain a distributed range of drop sizes.

Though not theoretically necessary, microemulsions tend to be significantly more thermodynamically stable than macroemulsions. Thermodynamically unstable emulsions can only be formed with externally supplied energy (i.e., stirring). The average discrete phase particle size in a thermodynamically unstable emulsion depends on a number of factors including the amount and form of the energy used to create the emulsion. Information describing the chemistry and physics of emulsions is plentiful in the literature (e.g., Gernon, M. D.; Alford, D.; Dowling, C. M.; Franco, G. P.; “Enhancing Oil/Water Emulsion Stability: The Use of Capillary Contact Angle Measurements to Determine Liquid/Liquid Interfacial Tensions between Aqueous Alkanolamine Solutions and Oils” Tribology Transactions 2009, 52(3), 405-414; and references cited therein). Emulsions are stabilized by the use of surfactants. The HLB (hydrophile/lipophile balance) of the surfactants used to stabilize a particular O/W emulsion must be matched to the properties of the oil phase being emulsified. Commercial emulsions and related aqueous surfactant solutions are oftentimes formulated with numerous components that perform diverse functions. In the area of partially aqueous lubricants, formulas containing lubricating oils, corrosion inhibitors, coupling agents, surfactants, amine neutralizing agents and biocides are common.

It has been found that N-alkylalkanolamines are, owing to their low odor and low vapor pressure, ideal neutralizing agents for functional fluids. Further, it has been found that N-alkylalkanolamines with the right balance of hydrophilic to hydrophobic properties are optimal for providing supplementary stabilizing benefits in partially aqueous functional fluids. Generally, more hydrophobic emulsions (i.e., emulsions containing more oil) are best formulated with more hydrophobic N-alkylalkanolamines, and less hydrophobic emulsions (i.e., emulsions containing less oil) are best formulated with more hydrophilic alkanolamines. Fully aqueous synthetic metalworking fluids (the term synthetic refers to fluids based on surfactants and lubricants derived from sources other than traditional petrochemical oils) generally use the most hydrophilic alkanolamines. The N-alkylalkanolamines described herein are unique in that they provide for more hydrophobic behavior, at a given C to combined (OH+NH₂+NH) ratio, than do N-alkylalkanolamines of alternative structures. Without being bound to theory it is assumed that the reason for this enhanced hydrophobic property may be related to altered hydrogen bonding to the hydroxyl function on the longer hydroxyalkyl group.

The evaluation of emulsions can be carried out by visual inspection. Macroemulsions with drop sizes in the order of 1 micron diameter appear to be “milky” in appearance. As the discrete phase drop size in an emulsion decreases, the appearance of the emulsion becomes more bluish and translucent. When the drop reaches 10-100 nm diameter, the emulsion appears to be clear. Below 10 nm in diameter, the oil drop starts to transition into a micelle like structure.

### EXAMPLES

### Example 1

### Preparation of the N-(2-hydroxyalkyl)-N-(2-hydroxyethyl)-N-alkylamines

A 1 mole quantity of 1,2-epoxyalkane (99% purity by GC/TCD, water<0.2%) was added slowly over 30 minutes to 1 mole of N-alkylethanolamine (99% purity by GC/TCD, water<0.2%) at RT. The solution temperature was monitored, but in no case was an exotherm observed. Note that the reaction of epoxides and amines can display an induction period followed by an exotherm. Water is known to catalyze this reaction, and increased levels of water may markedly increase the reaction rate. The solution was stirred at RT for several days with the course of the reaction monitored by GC/TCD. In some cases, cooling was occasionally applied for the first 8 hours in order to keep the reaction solution close to RT (mild heating to about 35° C. was occasionally observed). The reaction could be run in a cool room (T<15° C.) in order to reduce the amount of monitoring necessary. Alternatively, the reaction can be run in a sealed pressure vessel at elevated temperature and pressure (e.g., @ T=80° C., the reaction is complete within several hours) or in an open apparatus with accommodation for reflux of the ΔAA and/or epoxide. The RT reaction was left unmonitored after the first day. When the RT reaction reached 95% plus conversion, the product was transferred and directly vacuum distilled to yield the product as a clear liquid. When the reaction was run in a pressure reactor, a slight excess of epoxide was employed and the reaction was run to near completion. The small amount of epoxide and/or AAA remaining at the end was removed by distillation in-vacuo and the product was taken as is or distilled.

### N-(2-hydroxybutyl)-N-(2-hydroxyethyl)-N-butylamine (HBHEBA; CAS RN=1250529-85-1)

The crude reaction product was double vacuum distilled (110° C. @ 1 Torr) to yield material that was 99.8% pure by GC/TCD (88% yield). The distilled material was definitively identified by GC/MS, ¹H NMR and quantitative ¹³C NMR (10 carbon atoms, referenced to CDCl₃; 69.3, 60.8, 59.8, 56.5, 54.9, 29.1, 27.6, 20.5, 14.0, 9.9; no other signals observed).

### N-(2-hydroxyoctyl)-N-(2-hydroxyethyl)-N-butylamine (HOHEBA)

The crude reaction product was vacuum distilled (150° C. @ 2 Torr) to yield material that was 99.5% pure by GC/TCD (96% yield). The distilled material was definitively identified by GC/MS, ¹H NMR and quantitative ¹³C NMR (14 carbon atoms; referenced to CDCl₃; 67.9, 61.1, 59.7, 56.4, 54.8, 34.8, 31.7, 29.4, 29.0, 25.6, 22.5, 20.4, 14.0, 13.9; no other signals observed)

### N-(2-hydroxybutyl)-N-(2-hydroxyethyl)-ethylamine (HBHEEA; CAS RN=16681-36-0)

After the reaction reached ≈95% conversion (several days), the crude reaction product was analyzed as is. The crude reaction solution was determined by GC/TCD to be 95% of the target compound (HBHEEA) with 0.6% butylene oxide and 1.6% ethylaminoethanol remaining. The butylene oxide was stripped in-vacuo, and the HBHEEA was definitively identified by MS (GC/MS; CI; parent M+1 peak=162, 130, base peak=102, 72, 58, 42, 30).

The following starting materials are representative:

N-Alkylal kanolamine:

A) N-Butylethanolamine (CAS RN=111-75-1)

B) N-Propylethanolamine (CAS RN=16369-21-4)

C) N-Isopropylethanolamine (CAS RN=109-56-8)

D) N-Ethylethanolamine (CAS RN=110-73-6)

E) N-Butylpropanolamine (CAS RN 25250-77-5)

F) N-Propylpropanolamine (CAS RN 41063-30-3)

G) N-Isopropylpropanolamine (CAS RN 41063-31-4)

H) N-Ethylpropanolamine (CAS RN 40171-86-6)

1,2-Epoxyalkane:

i) 1,2-epoxyoctane (CAS RN=2984-50-1)

ii) 1,2-epoxyheptane (CAS RN=5063-65-0)

iii) 1,2-epoxyhexane (CAS RN=1436-34-6)

iv) 1,2-epoxypentane (CAS RN=1003-14-1)

v) 1,2-epoxybutane (CAS RN=106-88-7)

### Example 2

### Biochallenge Test with Phenoxyethanol

The following Table summarizes a biostability experiment. The concentrate formulas designated were diluted to 5% (aq) with tap water (250 ppm ionic content; volume maintained with DI water) and treated with 0.3% v/v of spoiled emulsion per week. The base emulsion without alkanolamine and/or phenoxyethanol had no resistance to bacterial growth. The rancid fluid is maintained by controlling the temperature at 22° C., adding fresh soluble oil emulsion occasionally as food, and adding spoiled emulsion from selected commercial metalworking sites at approximately 6 week intervals. In all cases, the same spoiled emulsion is used to treat all the fluids being tested. The bacterial level in the test fluids was checked using generic dipsticks with a TSA side for bacteria and an SAB side for fungus. The sticks were immersed in the fluid for 10 seconds and then incubated at 35° C. for 2 days prior to taking a bacterial count. The formulas and weekly bacterial counts are summarized below:

| | Formulation | | |
|---|---|---|---|
| Component | (component | | |
| N-octyldiethanolamine (C/OH = 6) | 5% | — | — |
| N-butyldiethanolamine (C/OH = 4) | — | 5% | — |
| HBHEBA (C/OH = 5) | — | — | 5% |
| Phenoxyethanol | 10% | 10% | — |
| 100 SUS Naphthenic Oil | 65% | 65% | 65% |
| Soluble Oil Package: | 20% | 20% | 20% |
| Sulfonated 100 SUS Naphthenic Oil | | | |
| Potassium Fatty Acid Soap | | | |
| Coupling Agents | | | |
| Water | — | — | 10% |
| | Bacteria Levels | | |
| Week | (log cfu/ml) | | |
| 1 | <3 | <3 | 3 |
| 2 | <3 | <3 | 3 |
| 3 | 3 | 3 | 5 |
| 4 | <3 | <3 | 3 |
| 5 | 4 | <3 | 6 |
| 6 | 5 | <3 | 6 |
| 8 | 5 | <3 | 5 |

The fluid based on HBHEBA {N-(2-hydroxybutyl)-N-(2-hydroxyethyl)-N-butylamine} is essentially as biostable without phenoxyethanol biocide as are fluids based on alternative AAA's of comparable C/OH ratios also containing phenoxyethanol. Phenoxyethanol is a commonly used alternative to formaldehyde-releasing biocides. Phenoxyethanol is significantly less toxic than most formaldehyde-releasing biocides and has ancillary applications as an anesthetic for fish and as an insect repellant.

### Example 3

### Biochallenge Test with Formula Variations

The following Table summarizes a biostability experiment. The concentrate formulas designated were diluted to 5% (aq) with tap water (250 ppm ionic content; volume maintained with DI water) and treated with 0.3% v/v of spoiled emulsion per week. The base emulsion without alkanolamine and/or other active material had no resistance to bacterial growth. The rancid fluid is maintained by controlling the temperature at 22° C., adding fresh soluble oil emulsion occasionally as food, and adding spoiled emulsion from selected commercial metalworking sites at approximately 6 week intervals. In all cases, the same spoiled emulsion is used to treat all the fluids being tested. The bacterial level in the test fluids was checked using generic dipsticks with a TSA side for bacteria and an SAB side for fungus. The sticks were immersed in the fluid for 10 seconds and then incubated at 35° C. for 2 days prior to taking a bacterial count. The formulas and weekly bacterial counts are summarized below:

| Component | Formulation (component wt/wt) | | | | | |
|---|---|---|---|---|---|---|
| DCHA (dicyclohexylamine) | 7% | — | — | — | — | — |
| HBHEBA (C/OH = 5) | — | 7% | 5% | 5% | 3% | 5% |
| DBAE (C/OH = 10) | — | — | — | — | 4% | 2% |
| Glycerol 2-Ethylhexyl Ester | — | — | 10% | — | — | — |
| 1,2-Octanediol | — | — | — | 10% | — | — |
| 100 SUS Naphthenic Oil | 65% | 65% | 65% | 65% | 65% | 65% |
| Soluble Oil Package: | 20% | 20% | 20% | 20% | 20% | 20% |
| Water | 8% | 8% | — | — | 8% | 8% |
| Week | Bacteria Levels (log cfu/ml) | | | | | |
| Initial | 0 | 0 | 0 | 0 | 0 | 0 |
| 1 | <3 | <3 | <3 | <3 | <3 | <3 |
| 2 | <3 | <3 | <3 | <3 | <3 | 4 |
| 3 | <3 | <3 | <3 | 5 | 4 | 6 |
| 4 | 4 | 4 | 5 | 6 | 6 | 6 |
| 5 | 5 | 4 | 6 | 6 | 6 | 6 |
| 6 | 7 | 4 | 6 | 6 | 6 | 6 |
| 7 | 6 | 4 | 6 | 6 | 6 | 6 |
| 8 | 7 | 5 | 6 | 6 | 6 | 6 |
| 9 | 6 | 5 | 6 | 6 | 6 | 6 |
| 10 | 7 | 4 | 6 | 6 | 6 | 6 |

The soluble oil package is a typical blend of Sulfonated 100 SUS naphthenic oil, potassium fatty acid soap and coupling agents. The fluid based on 7% HBHEBA {N-(2-hydroxybutyl)-N-(2-hydroxyethyl)-N-butylamine} in the concentrate is more biostable than a comparable fluid based on 7% DCHA (effective C/OH ratio of 0). Alternative formulations with lesser amounts of HBHEBA compensated for by the addition of alternative N-alkylalkanolamines (DBAE; N,N-dibutylaminoethanol; C/OH ratio=10) and/or other additives which modify the effective C/OH average for the system are also effective, but nothing is as effective as HBHEBA by itself.

### Example 4

### Challenge with Amines as Sole Biostabilizing Agent

The biostability of three fluids containing different amines was assessed in a challenge test format. The three amines used were DCHA (dicyclohexylamine), DBAE (dibutylaminoethanol) and HBHEBA (hydroxybutyl hydroxyethyl butylamine). The test solutions were approximately 100 ml in volume and maintained at RT. The following formula was used at 4% aqueous dilution for testing:

| | Amount | | | |
|---|---|---|---|---|
| | Grams | Percent | Pounds | Gallons |
| 100 SUS Naphthenic Oil^{note 1} | 76.25 | 53.40% | 229.60 | 30.49 |
| Focus Soluble Base 10^{note 2} | 15.00 | 10.50% | 45.17 | 5.27 |
| Lubrizol Syn-Ester GY-25^{note 3} | 3.00 | 2.10% | 9.03 | 1.08 |
| Focus Amide 5^{note 4} | 3.50 | 2.45% | 10.54 | 1.32 |
| Bioban P-1487^{note 5} | 1.00 | 0.70% | 3.01 | 0.33 |
| Foam Ban MS-575^{note 6} | 0.15 | 0.11% | 0.45 | 0.05 |
| SM-100 Odor Mask^{note 7} | 0.60 | 0.42% | 1.81 | 0.23 |
| Preventol CI 7-50^{note 8} | 0.50 | 0.35% | 1.51 | 0.15 |
| EZ-Mulz 4037N^{note 9} | 21.50 | 15.06% | 64.74 | 8.09 |
| AMINE | 7.10 | 4.97% | 21.38 | 2.67 |
| Low Rosin TOFA^{note 10} | 7.10 | 4.97% | 21.38 | 2.80 |
| Water | 7.10 | 4.97% | 21.38 | 2.56 |
| Total | 142.80 | 100.0% | 430.00 | 55.05 |

^{Note 1}100 SUS (Seyboldt Universal Seconds) Naphthenic Oil
^{Note 2}Soluble oil emulsifier package of Focus Chemicals (North Olmsted, OH)
^{Note 3}Synthetic monoalkyl succinate ester of Lubrizol Corp. (Wickliffe, Ohio)
^{Note 4}Fatty Diisoproanolamide of Focus Chemicals (North Olmsted, OH)
^{Note 5}Biocide of Dow Corporation (Midland, MI)
^{Note 6}Siloxane defoamer of Munzing Corporation (Heilbronn, Germany)
^{Note 7}Commercial odor mask of Ideas Incorporated (Lombard, IL)
^{Note 8}Formulated tolyl triazole corrosion inhibitor of Lanxess (Pittsburg, PA)
^{Note 9}Sulfonate free emulsifier base of Additives International (Evanston, IL)
^{Note 10}Low rosin tall oil fatty acid

The 100 ml test solutions were initially challenged with 10 ml of a lab maintained rancid soluble oil containing 50% tramp oil with an overall biological count of 8,800,000 CFU/ml. The degree of biological growth throughout the experiment was measured by the HMB-IV (Biotech International, Needville, Tex.) method for determination of the aerobic and facultative biological activity within a liquid metalworking fluid sample. This test method is based on the principle that most of the microorganisms in challenged metalworking fluids produce catalase while they are active. The addition of a known amount of a formulated HMB-IV oxidizing agent (hydrogen peroxide, buffer and chelating chemicals) to a standard volume of the sample fluid in a sealed test tube allows for an amount of oxygen proportional to the amount of active bacteria to be produced via the chemical reaction between active catalase enzyme and the hydrogen peroxide. A calibrated device is used to measure the amount of oxygen that is produced via the change in the pressure of the headspace within a test tube over a period of 15 minutes.

The second challenge at 3 days was 20 ml of a rancid semi-synthetic coolant with a CFU/ml reading of 10,000,000. A volume of 20 ml was necessary to bring the volume back to the original 100 ml (each CFU/ml measurement removes 10 ml of coolant). The third challenge at 10 days was an additional 20 ml of the 10,000,000 CFU/ml rancid semi-synthetic coolant. On the 18^{th} day, the three solutions all looked like they were on the brink of complete putrefaction, and, as the total volume of each solution was now down to 60 ml, a fresh 40 ml charge of the original solution (4% dilution) was added. After addition of fresh solution, all three test samples returned to a more normal appearance. After 25 days, the solution containing HBHEBA looked the best in that it had the least tramp oil, the best color, and the most translucent emulsion. The solutions were again tested after being idle for two months, and a large difference in CFU between the DCHA, DBAE & HBHEBA systems was noted. The HBHEBA performed the best. The results are summarized in the Table below.

| | DCHA | DBAE | HBHEBA |
|---|---|---|---|
| Amine Used | (No OH) | (C/OH = 12) | (C/OH = 5) |
| CFU one hour after first | 630,000 | 740,000 | 610,000 |
| challenge | | | |
| pH of test solution after first | 9.1 | 9.4 | 9.1 |
| challenge | | | |
| Putrification odor after first | none | none | none |
| challenge | | | |
| CFU @ 3 days (2^{nd} challenge) | 410,000 | 310,000 | 140,000 |
| CFU @ 7 days (4 days after | 3,000,000 | 2,100,000 | 3,300,000 |
| 2nd challenge) | | | |
| CFU @ 10 days (3^{rd} | 3,900,000 | 4,000,000 | 4,500,000 |
| challenge) | | | |
| CFU @ 14 days (4 days after | 3,900,000 | 2,500,000 | 2,900,000 |
| 3rd challenge) | | | |
| CFU @ 25 days (7 days after | 4,000,000 | 2,900,000 | 1,700,000 |
| fresh dilution) | | | |
| pH of test solution @ 25 days | 8.2 | 8.2 | 8.2 |
| Putrification odor @ 25 days | none | none | none |
| CFU @ 90 days (60 day idle | 33,000,000 | 8,100,000 | 7,700,000 |
| period simulation) | | | |
| pH of test solution @ 90 days | 7.7 | 7.7 | 7.6 |

The novel structure of HBHEBA resulted in a greater than expected boost to biostability and also in a greater ability of the emulsion to resist the demulsifying effect of biological growth. The redistribution of the hydrophobic portion of HBHEBA throughout the molecule, as opposed to its localization solely in the alkyl group, provides for an unexpected increase in emulsion stability and in biological stability relative to other tertiary amines with a range of HLB (calculated hydrophile to lipophile balance) values from very hydrophobic to very hydrophilic.

### Example 5

### Comparative Emulsion Stability

Emulsions were prepared by mixing 10 grams of p-terphenyl oil (density=1.24) with 10 grams of 20% wt/wt aqueous AAA solution in a sealed 20 ml vial with 10 seconds of vortex shaking. The emulsion prepared with aqueous N-butyldiethanolamine (BDEA, C/OH ratio=4) was compared to an otherwise identical emulsion prepared with 20% aqueous N-(2-hydroxybutyl)-N-(2-hydroxyethyl)-N-ethylamine (HBHEEA, C/OH ratio=4). The BDEA based emulsion showed significant oil coalescence within 15 minutes and complete phase separation within 30 minutes. The HBHEEA based emulsion remained completely opaque with no visible signs of coalescence for several hours prior to the initiation of oil phase coalescence. Oil in water emulsions prepared with p-terphenyl and HBHEEA are significantly more stable than similar emulsions prepared with traditional AAA's of comparable C/OH ratio and HLB (hydrophile/lipophile balance). The HLB is calculated as (104/MW)*20 for tertiary dilkanolamines such as BDEA and HBHEEA.

### Example 6

### Biostability Comparison of BDEA (BAE-EO), BAE-PO and BAE-BO (HBHEBA)

A challenge test comparison of the following soluble oil emulsion was carried out over several days.

| | |
|---|---|
| 77 parts | 100 SUS Naphthenic Oil |
| 15 parts | Soap/Sulfonate Emulsifier^{note a} |
| 7 parts | Chlorinated Paraffin^{note b} |
| 1 part | Bioban P1487^{note c} |
| 3 part or 5 part | AAA^{note d} |

^{note a}Focus Chemicals, North Olmsted, OH, Soluble oil emulsifier
^{note b}Dover Chemical, Dover, Ohio, Dover 53NR, Chlorinated medium chain length paraffin
^{note c}Dow Chemical, Midland, MI, blend of 4-(2-nitrobutyl)-morpholine & 4,4′-(2-ethyl-2-nitrotrimethylene)-dimorpholine)
^{note d}BAE = butylethanolamine BAE-EO = BDEA (butyldiethanolamine) = BAE + ethylene oxide BAE-PO is propoxylated BAE (BAE + propylene oxide) BAE-BO is butoxylated BAE (BAE + epoxybutane)

The above concentrate formula was used with either 3 or 5 parts of one of the test amines. The soluble oil concentrate was diluted 20 to 1 in stagnant water made up from spoiled coolant (cultured from an original stock of rancid metalworking coolant used in a ferrous alloy cutting operation) which was in turn prepared by diluting 10% of a 60,000,000 CFU per ml of stock spoiled coolant with 90% tap water that had been allowed to air out for 24 hours. The challenge solution, which in this experiment is a control, was calculated to initially contain 6,000,000 CFU per ml microbial population. By the next day, the microbial content of the challenge solution had increased to 13,000,000 CFU per ml. By the end of the trial, the microbial content of the challenge solution had declined to 7,400,000 CFU. The concentration of microbes was determined by oxygen pressure development as described in Example 4.

The results are as follows:

CFU per ml × 10⁶

| Formula | after 1 day | after 4 days |
|---|---|---|
| BAE-EO @ 3% | 11 | 9.0 |
| BAE-PO @ 3% | 16 | 5.0 |
| BAE-BO @ 3% | 7.3 | 5.0 |
| BAE-EO @ 5% | 3.5 | 2.1 |
| BAE-PO @ 5% | 3.1 | 1.4 |
| BAE-BO @ 5% | 3.0 | 1.2 |
| NO AAA | 5.8 | 2.7 |
| CHALLENGE | 13 | 5.0 |

At 3% AAA in the concentrate, the AAA content is 1500 ppm in the diluted and challenged solution. At 5% AAA in the concentrate, the AAA content is 2500 ppm in diluted and the challenge solution. The effect at a AAA concentration less than 2000 ppm is less dramatic than the effect at a AAA concentration of 2500 ppm. The ranking of BAE-BO (HBHEBA)>BAE-PO>BAE-EO (BDEA) in terms of biostability enhancement is supported by the data.

### Example 7

### Interfacial Tension Measurements

Drop weight measurements (i.e., the weight of a drop of one fluid as it is carefully released into another immiscible fluid) were used to evaluate the air/liquid and liquid/liquid interfacial tensions of 5% BDEA(aq) (butyldiethanolamine with C/OH ratio of 4), 5% HBHEEA(aq) (hydroxybutyl hydroxyethyl ethylamine with C/OH ratio of 4) and 2% HBHEBA(aq) (hydroxybutyl hydroxyethyl butylamine with C/OH ratio of 5) solutions at RT (22° C.). Note that a solution of 2% wt/wt of HBHEBA in water takes several minutes to form. About 1% wt/wt of HBHEBA dissolves in water fairly rapidly with stirring, while up to approximately 3% wt/wt can eventually be dissolved if stirring is continued for a longer period of time. The following relationship (oftentimes referred to as Tate's law) is used to relate drop weight to the interfacial tension between the drop fluid and the fluid being “dropped” into:

Force around rim of orifice releasing drop=Effective Drop Force

Force around rim of orifice releasing drop=2πrγ

γ=interfacial tension between drop and fluid

r=radius of the pipette orifice delivering the drop

Effective Drop Force=V(ρ_{drop}−ρ_{fluid})g

V=Volume of drop=actual mass of drop÷ density of drop

g=acceleration of gravity (981 cm/sec²)

ρ_{drop}=density of drop; ρ_{fluid}=density of fluid dropped into

ρ_{drop}−ρ_{fluid}=difference in density between drop and fluid

2πrγ=V(ρ_{drop}−ρ_{fluid})g

Effective Drop Mass=m_{effective}=V(ρ_{drop}−ρ_{fluid})

Actual Measured Drop Mass=m_{actual}=Vρ_{drop}

m_{effective}=m_{actual}−Vρ_{fluid}=m_{actual}−(m_{actual}/ρ_{drop})ρ_{fluid}=m_{actual}(1−ρ_{fluid}/ρ_{drop})

2πrγ=(m_{effective})g

2πrγ=m_{actual}(1−ρ_{fluid}/ρ_{drop})g

γ=m_{actual}(1−ρ_{fluid}/ρ_{drop})g/(2πr)

Drop weights were taken 10 at a time and averaged. Three replicates of the drop average were taken to insure accuracy. If three replicates failed to reproduce, then more measurements were taken until three replicates in a row of the 10 drop average were consistent. The Table below contains drop weight data of some aqueous AAA solutions as dropped into air and into decane (ρ=0.73 g/ml):

| | | | | | | γ (dynes/ |
|---|---|---|---|---|---|---|
| | | | | | | cm) |
| Drop | Fluid | 10 × Drop | Density | Density | | Drop |
| Phase | Phase | Weight | of Drop | of Fluid | | to Fluid |
| DI Water | Air | 0.560 g | 1.00 g/ml | 1 | mg/ml | 72 |
| | | | | | | (reference) |
| 5% | Air | 0.315 g | 1.00 g/ml | 1 | mg/ml | 41 |
| BDEA | | | | | | |
| (aq) | | | | | | |
| 5% | Air | 0.285 g | 1.00 g/ml | 1 | mg/ml | 37 |
| HBHEEA | | | | | | |
| (aq) | | | | | | |
| 2% | Air | 0.260 g | 1.00 g/ml | 1 | mg/ml | 34 |
| HBHEBA | | | | | | |
| DI Water | Decane | 1.4100 g | 1.00 g/ml | 0.73 | g/ml | 49 |
| 5% | Decane | 0.380 g | 1.00 g/ml | 0.73 | g/ml | 13 |
| BDEA | | | | | | |
| (aq) | | | | | | |
| 5% | Decane | 0.490 g | 1.00 g/ml | 0.73 | g/ml | 17 |
| HBHEEA | | | | | | |
| (aq) | | | | | | |
| 2% | Decane | 0.240 g | 1.00 g/ml | 0.73 | g/ml | 8 |
| HBHEBA | | | | | | |

The data for DI water dropped into air is used to standardize the pipette. The surface tension of water/air at 22° C. and 1 bar absolute P is 72 dynes/cm.

Using this value in the equation for DI water gives an orifice radius of 1.2 mm (0.12 cm). All of the measurements were carried out with the same pipette. Using the value of 1.2 mm as the radius of the pipette orifice allows for accurate calculation of the unknown interfacial tensions. Both BDEA and HBHEEA have the same MW and the same total C/OH ratio of 4, but both molecules display distinct interfacial tension properties. A 5% wt/wt aqueous solution of HBHEEA provides for a greater decrease in air/liquid interfacial tension than does a comparable 5% wt/wt aqueous solution of BDEA. To the contrary, a 5% wt/wt aqueous solution of BDEA provides for a greater decrease in liquid/liquid interfacial tension with an oil phase of decane than does a comparable 5% wt/wt aqueous solution of HBHEEA. AAA's of identical total C/OH ratio and identical MW but with differing distribution of hydrophobic and hydrophilic regions display unique properties with respect to solubility, viscosity, volatility, impact on emulsion stability, and assistance to biostability. HBHEBA, with a C/OH ratio of 5, displayed markedly superior properties with respect to both lowering air/liquid interfacial tension and liquid/liquid (oil phase=decane) interfacial tension as compared to the C/OH=4 molecules BDEA and HBHEEA.

1. A liquid containing water, an organic compound which forms a biphasic system with water and at least 100 mg/kg of a tertiary alkanolamine of the following formula (I):
R—CH(OH)CH₂—NR′—CH₂CH(OH)—R″ (I)
wherein:
R=hexyl, pentyl, butyl, propyl, ethyl or a structural isomer of hexyl, pentyl, butyl or propyl
R′=butyl, sec-butyl, isobutyl, tert-butyl, propyl, isopropyl or ethyl
R″═H or methyl or hexyl, pentyl, butyl, propyl, ethyl or a structural isomer of hexyl, pentyl, butyl or propyl.

2. A liquid as claimed in claim 1, wherein in said formula (I) R″═H or methyl.

3. A liquid as claimed in claim 2, wherein in said formula (I)
R=hexyl, pentyl, butyl, propyl or ethyl
R′=butyl, propyl, isopropyl or ethyl.

4. A liquid as claimed in claim 1, wherein in said formula (I)
R=hexyl, pentyl, butyl, propyl, ethyl or a structural isomer of hexyl, pentyl, butyl or propyl.

5. A liquid as claimed in claim 4, wherein in said formula (I)
R & R″=hexyl, pentyl, butyl, propyl or ethyl
R′=butyl, propyl, isopropyl or ethyl.

6. A liquid as claimed in claim 1, wherein in said formula (I) R is different from R″.

7. A liquid as claimed in claim 1, which liquid contains at least 1000 mg/kg of said tertiary alkanolamine.

8. A liquid as claimed in claim 1, which liquid contains less than 0.5 kg/kg of said tertiary alkanolamine.

9. A liquid as claimed in claim 1, which liquid has a pH of at least 8.

10. A liquid as claimed in claim 1, which liquid is a metalworking fluid, an emulsion lubricant, a coolant, a synthetic lubricant and/or a partially aqueous functional fluid.

11. A liquid as claimed in claim 1, which liquid contains at least one surfactant, different from the tertiary alkanolamine of formula (I).

12. A liquid as claimed in claim 1, which liquid is an emulsion.

13. A liquid as claimed in claim 12, which liquid is an oil in water emulsion or a water in oil emulsion.

14. Use of a liquid as claimed in claim 1 as a metalworking fluid, an emulsion lubricant, a coolant, a synthetic lubricant and/or a partially aqueous functional fluid.

15. A method for increasing the physical stability of an emulsion comprising employing a tertiary amine of formula (I)
R—CH(OH)CH₂—NR′—CH₂CH(OH)—R″ (I)
wherein:
R=hexyl, pentyl, butyl, propyl, ethyl or a structural isomer of hexyl, pentyl, butyl or propyl
R′=butyl, sec-butyl, isobutyl, tert-butyl, propyl, isopropyl or ethyl
R″═H or methyl or hexyl, pentyl, butyl, propyl, ethyl or a structural isomer of hexyl, pentyl, butyl or propyl in an emulsion.

16. A method for inhibiting microbial growth in a liquid comprising employing a tertiary amine of formula (I)
R—CH(OH)CH₂—NR′—CH₂CH(OH)—R″ (I)
wherein:
R=hexyl, pentyl, butyl, propyl, ethyl or a structural isomer of hexyl, pentyl, butyl or propyl
R′=butyl, sec-butyl, isobutyl, tert-butyl, propyl, isopropyl or ethyl
R″═H or methyl or hexyl, pentyl, butyl, propyl, ethyl or a structural isomer of hexyl, pentyl, butyl or propyl in a liquid
